(19) United States
(12) Patent Application Publication
(10) Pub. No.: US 2021/0087654 A1
(43) Pub. Date: Mar. 25, 2021

(54) ALUMINUM ALLOY MATERIAL

(71) Applicants: HONDA MOTOR CO., LTD., Mitato-ku (JP); SHOWA DENKO K.K., Tokyo (JP)

(72) Inventors: Takumi MARUYAMA, Fukushima (JP); Masashi KAWAKAMI, Wako-shi (JP); Takahiro KOJIMA, Wako-Shi (JP); Ryuta MOTANI, Wako-Shi (JP)

(73) Assignees: HONDA MOTOR CO., LTD., Mitato-ku (JP); SHOWA DENKO K.K., Tokyo (JP)

(21) Appl. No.: 17/111,881

(22) Filed: Dec. 4, 2020

Related U.S. Application Data
(62) Division of application No. 15/985,880, filed on May 22, 2018.

(30) Foreign Application Priority Data
May 23, 2017 (JP) 2017-101481

(51) Int. Cl. C22C 21/02; C22F 1/043

(52) U.S. Cl. CPC C22C 21/02; F16C 7/023; C22F 1/043

(57) ABSTRACT

Provided is an aluminum alloy material with high strength and low thermal expansion coefficient even under high temperature environments. An aluminum alloy material according to the present invention has a composition consisting of: Si: 13 mass % to 15 mass %, Cu: 2.0 mass % to 6.0 mass %, Mg: 0.2 mass % to 1.5 mass %, Fe: 0.4 mass % to 0.8 mass %, Ni: 0.2 mass % to 0.8 mass %, P: 0.005 mass % to 0.015 mass %, and the balance being Al and inevitable impurities.

### BACKGROUND OF THE INVENTION

### Technical Field

The present disclosure relates to an aluminum alloy material suitably used as, for example, a connecting rod (hereinafter also referred to as “conrod”) which is a rod for connecting a piston and a crank representing automobile engine parts, and also relates to a related technique thereof.

### Description of the Related Art

In the recent automotive industry, improvement in fuel economy is strongly demanded. Along with that, demands for weight reduction and higher functionality of various members used in automobiles, such as, e.g., a piston and a conrod of an internal combustion engine, are increasing more than ever.

With respect to such various members for automobiles, in place of a conventional steel material and cast iron material, there is a higher tendency to use an aluminum alloy material with high specific strength which is the ratio of strength to weight. Among others, as a member capable of withstanding harsh environments, such as, e.g., under a high temperature atmosphere, as typified by the aforementioned various members for automobiles, a forged material made of an aluminum alloy, such as, e.g., an Al—Si based alloy, having high strength at high temperature has been drawing attention.

In producing this kind of aluminum alloy forged material, as described in, for example, Patent Document 1, it has been commonly practiced to perform hot extrusion processing on powders obtained by quenching and solidifying an aluminum alloy molten metal of a predetermined component composition by an atomizing method or the like and die forging the obtained extruded material into a predetermined product shape.

### PRIOR ART

### Patent Document

Patent Document 1: Japanese Unexamined Patent Application Publication No. H02-277751

### SUMMARY OF THE INVENTION

### Problems to be Solved by the Invention

When hot forging an extruded material of aluminum alloy atomized powder as a forging material like in the conventional method for producing an aluminum alloy forged material shown in Patent Document 1, due to the high deformation resistance, the die life is likely to be decreased.

Under the circumstances, in order to avoid reduction of the die life, instead of using an extruded material of aluminum alloy atomized powder, there is a case of selecting a method of forming a conrod by die forging a conventional general cast material as a forging material. However, in the case of selecting this method, there was a problem that the properties under high temperature of 150° C. which is the conrod's usage environment, especially strength such as fatigue strength and low thermal expansion coefficient, were lower than those in the case of using an atomized powder extruded material.

The disclosed embodiments of this disclosure have been developed in view of the above-mentioned and/or other problems in the related art. The disclosed embodiments of this disclosure can significantly improve upon existing methods and/or apparatuses.

Some embodiments of this disclosure have been made in view of the aforementioned problems, and aim to provide an aluminum alloy material having desired properties such as high strength and low thermal expansion coefficient even under severe usage environments such as high temperature environments without using an atomized powder extruded material, and also aim to provide its related technology.

The other purposes and advantages of some embodiments of the present invention will be made apparent from the following preferred embodiments.

### Means for Solving the Problems

In order to solve the aforementioned problems, some embodiments of the present invention have the following structure.

[1] An aluminum alloy material having a composition consisting of: Si: 13 mass % to 15 mass %, Cu: 2.0 mass % to 6.0 mass %, Mg: 0.2 mass % to 1.5 mass %, Fe: 0.4 mass % to 0.8 mass %, Ni: 0.2 mass % to 0.8 mass %, P: 0.005 mass % to 0.015 mass %, and the balance being Al and inevitable impurities.

[2] The aluminum alloy material as recited in the aforementioned Item [1], wherein Cu is 4.2 mass % to 4.8 mass %, Mg is 0.4 mass % to 0.6 mass %, and Fe is 0.4 mass % to 0.6 mass %.

[3] The aluminum alloy material as recited in the aforementioned Item [1] or [2], wherein the composition further includes at least one component selected from the group consisting of Mn: 0.01 mass % to 0.50 mass %, Ti: 0.01 mass % to 0.30 mass %, and Zr: 0.01 mass % to 0.30 mass %.

[4] A connecting rod for vehicles, the connecting rod being constituted by the aluminum alloy material as recited in any one of the aforementioned Items [1] to [3].

[5] A method for producing an aluminum material, comprising:

producing a cast material by casting an aluminum alloy molten metal having a composition consisting of: Si: 13 mass % to 15 mass %, Cu: 2.0 mass % to 6.0 mass %, Mg: 0.2 mass % to 1.5 mass %, Fe: 0.4 mass % to 0.8 mass %, Ni: 0.2 mass % to 0.8 mass %, P: 0.005 mass % to 0.015 mass %, and the balance being Al and inevitable impurities; and

producing an aluminum alloy material based on the cast material.

[6] The method for producing an aluminum alloy material as recited in the aforementioned Item [5], wherein the aluminum alloy molten metal includes Cu: 4.2 mass % to 4.8 mass %, Mg: 0.4 mass % to 0.6 mass %, and Fe: 0.4 mass % to 0.6 mass %

[7] The method for producing an aluminum alloy material as recited in the aforementioned Item [5] or [6], wherein the aluminum alloy molten metal includes one or more of Mn: 0.01 mass % to 0.50 mass %, Ti: 0.01 mass % to 0.30 mass %, and Zr: 0.01 mass % to 0.30 mass %.

[8] The method for producing an aluminum alloy material as recited in any one of the aforementioned Items [5] to [7], wherein the aluminum alloy material is produced by subjecting the cast material to a homogenization treatment, and then forging the homogenized cast material.

[9] The method for producing an aluminum alloy material as recited in any one of the aforementioned Items [5] to [7], wherein the cast material is subjected to extrusion processing to produce an extruded material, the extruded material is subjected to a homogenization treatment, and then the homogenized extruded material is forged to produce an aluminum alloy material.

[10] The method for producing an aluminum alloy material as recited in any one of the aforementioned Items [5] to [7], wherein the cast material is subjected to a homogenization treatment, and then the homogenized cast material is forged to produce a forged material, and the forged material is subjected to a solution treatment, a water quenching treatment, and an artificial aging treatment to produce an aluminum alloy material.

[11] The method for producing an aluminum alloy material as recited in any one of the aforementioned Items [5] to [7], wherein the cast material is subjected to a homogenization treatment and then forged to produce a forged material, and wherein the forged material is subjected to a solution treatment, a water quenching treatment, and an artificial aging treatment, and then subjected to a shot peening treatment to produce an aluminum alloy material.

[12] A method for producing a connecting rod for vehicles, wherein the connecting rod for vehicles is produced using the aluminum alloy material produced by the method as recited in any one of the aforementioned Items [5] to [11].

### Effects of the Invention

According to the aluminum alloy material as recited in the aforementioned Items [1] to [3], since it has a specific alloy composition, it has sufficient strength and low thermal expansion coefficient even under high temperature environment.

According to the connecting rod for vehicles as recited in the aforementioned Items [4], since it has a specific alloy composition, it has sufficient strength and low thermal expansion coefficient even under high temperature environment.

According to the method for producing the aluminum alloy material as recited in the aforementioned Item [5] to [11], an aluminum alloy material having sufficient strength and low thermal expansion coefficient even under high temperature environment can be produced.

According to the method for producing the connecting rod for vehicles of the invention [12], a connecting rod for vehicles having sufficient strength and low thermal expansion coefficient even under high temperature environment can be produced.

### BRIEF DESCRIPTION OF THE DRAWINGS

FIG. 1 is a flowchart showing an example of a production process of a connecting rod for automobiles according to an embodiment of the present invention.

FIG. 2 is a perspective view showing a cast material based on a method for producing an aluminum alloy material according to the embodiment.

FIG. 3 is a perspective view showing a forged material based on a method for producing an aluminum alloy material according to the embodiment.

### EMBODIMENTS FOR CARRYING OUT THE INVENTION

The conrod for automobiles which is an embodiment of the present invention is constituted by a predetermined aluminum alloy material. It should be noted that in this embodiment, “%” as an additive amount (content) is used in the sense of “mass %”.

The aluminum alloy material as a conrod in this embodiment has a composition consisting of Si: 13% to 15%, Cu: 4.2% to 4.8%, Mg: 0.4% to 0.6%, Fe: 0.4% to 0.6%, Ni: 0.2% to 0.8%, P: 0.005% to 0.015%, and the balance being Al and inevitable impurities.

In this embodiment, the additive amount (content) of each composition component (additive element) of the aluminum alloy material and its effects are as follows.

The additive amount of Si is 13% to 15%. Si has an effect of improving high temperature strength and an effect of lowering thermal expansion. This effect is hard to appear when the additive amount of Si is less than 13%, and particularly noticeably appears at 13% or more. When the additive amount of Si exceeds 15%, the forging processability deteriorates, and further the crystallization of the primary crystal Si increases and elongation at room temperature decreases, and the cutting blade for use in a cutting process is likely to be chipped due to the existence of the primary crystal Si which is harder than aluminum. For this reason, the additive amount of Si needs to be set to 13% to 15%, preferably 13.5% to 14.5%.

The additive amount of Cu is 4.2% to 4.8%. Cu has an effect of improving the high temperature strength, particularly the strength at 150° C. which is a practical temperature range of a conrod. This effect is due to the precipitation of Cu, and the aforementioned effect can be obtained by performing artificial aging. By adding simultaneously with Ni, it is crystallized as an Al—Ni—Cu based compound and dispersion-strengthened, and therefore there is an effect of further improving the high temperature strength. Both effects are difficult to appear when the additive amount of Cu is less than 4.2%, and remarkably appear at 4.2% or more. When it exceeds 4.8%, the aforementioned effect becomes difficult to remarkably appear, and the specific strength may not be improved due to an increase in specific gravity. Therefore, the additive amount of Cu needs to be set to 4.2% to 4.8%, more preferably 4.4% to 4.6%.

The additive amount of Mg is 0.4% to 0.6%. Mg has an effect of improving high temperature strength. Mg is solid-soluted during continuous casting and forms a compound with Si and Cu during artificial aging to be precipitated, and therefore there is an effect of improving the strength at 150° C. which is a practical temperature range of a conrod. This effect is hard to appear when the additive amount of Mg is less than 0.4%, and remarkably appears at 0.4% or more. When it exceeds 0.6%, the aforementioned effect will not appear noticeably. For this reason, the additive amount of Mg needs to be set to 0.4% to 0.6%, more preferably 0.45% to 0.55%.

The additive amount of Fe is 0.4% to 0.6%. When Fe is added simultaneously with Si, an Al—Fe—Si compound is crystallized, which contributes to dispersion-strengthening and causes an effect of improving the strength in a practical temperature range of a conrod. This effect is hard to appear when the additive amount of Fe is less than 0.4%, and remarkably appears at 0.4% or more. On the other hand, when it exceeds 0.6%, a coarsened compound crystallizes, possibly leading to deterioration of ductility. For this reason, the additive amount of Fe needs to be set to 0.4% to 0.6%, more preferably 0.45% to 0.55%.

The additive amount of Ni is 0.2% to 0.8%. Ni has an effect of improving high temperature strength and an effect of lowering thermal conductivity. When Ni is added simultaneously with Cu, an Al—Cu—Ni compound is crystallized, contributing to dispersion-strengthening, which causes an effect of improving the strength in a target temperature range. This effect is hard to appear when the additive amount of Ni is less than 0.2%, and remarkably appears at 0.2% or more. When it exceeds 0.8%, a coarse crystallized substance crystallizes and the ductility may decrease. For this reason, the additive amount of Ni is 0.2% to 0.8%, more preferably 0.3% to 0.7%.

The additive amount of P is 0.005% to 0.015%. P forms an AlP compound to become a nucleus of a primary crystal Si and has an effect of contributing to miniaturization and uniform dispersion of the primary crystal Si. This effect is hard to appear when the additive amount of P is less than 0.005%, and appears remarkably at 0.005% or more. On the other hand, when it exceeds 0.015%, molten metal flowability decreases and casting may become difficult. For this reason, the additive amount of P needs to be set to 0.005% to 0.015%, more preferably 0.007% to 0.013%.

Mn is preferably added in the range of 0.01 to 0.5%. That is, when Mn is added simultaneously with Si, an Al—Mn—Si based compound is crystallized to contribute to dispersion-strengthening, and some of them solid-solutes in the Al mother phase at the time of a solution treatment to precipitate as a fine precipitate during the artificial aging treatment, which contributes to fatigue strength improvement in a practical temperature range of a conrod. This effect is hard to appear when the additive amount of Mn is less than 0.01%, and remarkably appears at 0.01% or more. When it exceeds 0.5%, it is crystallized earlier than the Al mother phase into a coarse crystallized substance, possibly causing ductility deterioration. Therefore, in the case of adding Mn, it is preferable to add by 0.01% to 0.5%, more preferably 0.1 to 0.3%.

Ti is preferably added in the range of 0.01% to 0.3%. That is, by adding fine Ti, it solid-solutes in the Al mother phase during casting, and is concentrated at the time of the artificial aging treatment, leading to matrix reinforcement, which contributes to fatigue strength improvement in a practical temperature range of a conrod. This effect is hard to appear when the additive amount of Ti is less than 0.01%, and remarkably appears at 0.01% or more. On the other hand, when it exceeds 0.3%, the compound containing Ti may be coarsely crystallized, which may cause ductility decrease. For this reason, in the case of adding Ti, it is preferable to add by 0.01% to 0.3%, more preferably 0.05% to 0.10%.

Zr is preferably added in the range of 0.01% to 0.3%. That is, by slightly adding Zr, it solid-solutes in the Al mother phase during casting and thickens during artificial aging treatment, leading to matrix strengthening. By simultaneously adding Ti, nanoscale precipitates with an L12 structure is generated as an Al—(Ti, Zr) based alloy during artificial aging treatment, which contributes to fatigue strength improvement in a practical temperature range of a conrod. This effect is hard to appear when the additive amount of Zr is less than 0.01%, and remarkably appears at 0.01% or more. On the other hand, when it exceeds 0.3%, the compound containing Zr may be coarsely crystallized, which may cause ductility decrease. For this reason, the additive amount of Zr needs to be set to 0.01% to 0.3%, more preferably 0.05% to 0.10%.

In this embodiment, for example, by melting the aluminum alloy material by a well-known method, an aluminum alloy molten metal having the aforementioned alloy composition is prepared, and a continuously cast material (billet) is produced by continuous casting using the molten metal. Furthermore, the continuously cast material is subjected to a heat treatment and then subjected to plastic working, such as, e.g., a forging process. Thus, a low thermal expansion aluminum alloy material for a conrod according to this embodiment is obtained.

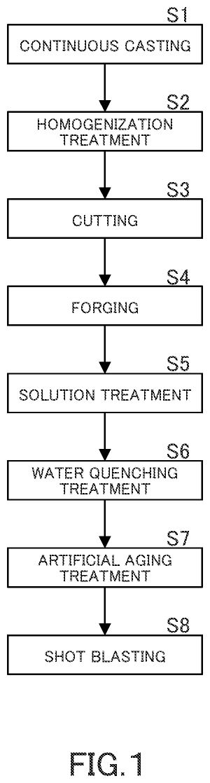

Next, an example of a process of producing an aluminum alloy material for a conrod according to this embodiment will be described in detail with reference to FIG. 1.

Initially, an aluminum alloy molten metal in which ingredients have been adjusted as described above is prepared by melting. Continuous casting is carried out using this molten metal as shown in FIG. 1 to produce a continuously cast material (Step S1). In this embodiment, this continuously cast material is configured as a billet for a forging material, and is formed into a round bar shape with a diameter of, for example, 30 mm to 40 mm.

In the present invention, an extrusion billet may be produced by continuous casting and extruded to form an extruded material to be used as a forging material. However, in that case, the production cost increases since the extrusion processing is carried out. Therefore, it is advantageous to produce a billet for a forging material by continuous casting (casting step).

In the obtained continuously cast material, since segregation of a crystallized substance, etc., may occur during casting, in order to remove the non-uniform structure, a homogenization treatment is carried out as shown in Step S2. In the homogenization treatment, it is preferable that the heating temperature be set to 480° C. to 505° C. and the processing time be set to 0.5 hours to 6 hours.

After the homogenization treatment, the continuously cast material is cut into a predetermined length to obtain a forging material as shown in Step S3.

The forging material obtained in this manner is subjected to a forging process as shown in Step S4 to form a forged material. In this forging step, it is preferable to set the die temperature at 100° C. to 250° C. and the material temperature at 370° C. to 450° C.

Next, this forged material is subjected to a solution treatment as shown in Step S5. In this solution treatment, it is preferable that the heating temperature be set to 485° C. to 510° C. and the processing time be set to 1.0 hour to 5.0 hours.

The forged material subjected to the solution treatment is subjected to a water quenching treatment to be quickly cooled as shown in Step S6. In this water quenching treatment, the water temperature is preferably set to 10° C. to 80° C.

The forged material to which the water quenching treatment was performed is subjected to an artificial aging treatment as shown in Step S7. In this artificial aging treatment, it is preferable to set the heat treatment temperature to 160° C. to 220° C. and the processing time to 1 hour to 18 hours.

After performing the artificial aging treatment, the surface of the forged material (forged T6 treated product) to which the artificial aging treatment was performed is cut by machining. After the cutting, perform shot blasting (shot peening) is carried out on the forged material as shown in Step S8. This shot blasting is a treatment for improving the fatigue strength by peening shots to the surface of the forged material to give a compressive stress to cause plastic deformation of the surface of the forged material. In this shot blasting, it is preferable that the size of the shot media (abrasive grain size) be about 1 mm or less in diameter, the abrasive grain type be SUS304 (JIS material symbol), alumina, etc., and the pressure of peening gas be 1 MPa or less.

In this way, an aluminum alloy material (forged material) for a conrod according to this embodiment is produced. In the conrod produced using the aluminum alloy material obtained as described above, in the conrod produced using the aluminum alloy material thus obtained, it is excellent in normal temperature strength and high temperature strength, especially high in thermal fatigue strength under high temperature against low thermal expansion property by joining with iron part and repeated loading, which is possible to obtain high performance as a conrod.

### Example 1

Hereinafter, Examples related to the present invention and Comparative Examples to be compared with Examples will be described in detail.

TABLE 1

| | Production | Component composition Mass % | | | | | | | | | |
|---|---|---|---|---|---|---|---|---|---|---|---|
| Sample | method | Si | Cu | Mg | Fe | Ni | P | Mn | Ti | Zr | Al |
| Ex. 1 | Continuous | 14 | 4.5 | 0.5 | 0.5 | 0.5 | 0.01 | | | | bal |
| | casting | | | | | | | | | | |
| Ex. 2 | Continuous | 15 | 4.8 | 0.6 | 0.6 | 0.8 | 0.01 | | | | bal |
| | casting | | | | | | | | | | |
| Ex. 3 | Continuous | 13 | 4.2 | 0.4 | 0.4 | 0.2 | 0.01 | | | | bal |
| | casting | | | | | | | | | | |
| Ex. 4 | Extrusion | 14 | 4.5 | 0.5 | 0.5 | 0.5 | 0.01 | 0.2 | | | bal |
| Ex. 5 | Continuous | 14 | 4.5 | 0.5 | 0.5 | 0.5 | 0.01 | | 0.1 | | bal |
| | casting | | | | | | | | | | |
| Ex. 6 | Continuous | 14 | 4.5 | 0.5 | 0.5 | 0.5 | 0.01 | | | 0.1 | bal |
| | casting | | | | | | | | | | |
| Ex. 7 | Extruding | 14 | 4.5 | 0.5 | 0.5 | 0.5 | 0.01 | | | | bal |
| Comp. Ex. 8 | Continuous | 12.5 | 4.5 | 0.5 | 0.5 | 0.5 | 0.01 | | | | bal |
| | casting | | | | | | | | | | |
| Comp. Ex. 9 | Continuous | 17 | 4.5 | 0.5 | 0.5 | 0.5 | 0.01 | | | | bal |
| | casting | | | | | | | | | | |
| Comp. Ex. 10 | Continuous | 14 | 3.5 | 0.5 | 0.5 | 0.5 | 0.01 | | | | bal |
| | casting | | | | | | | | | | |
| Comp. Ex. 11 | Continuous | 14 | 5.6 | 0.5 | 0.5 | 0.5 | 0.01 | | | | bal |
| | casting | | | | | | | | | | |
| Comp. Ex. 12 | Continuous | 14 | 4.5 | 0.3 | 0.5 | 0.5 | 0.01 | | | | bal |
| | casting | | | | | | | | | | |
| Comp. Ex. 13 | Continuous | 14 | 4.5 | 0.8 | 0.5 | 0.5 | 0.01 | | | | bal |
| | casting | | | | | | | | | | |
| Comp. Ex. 14 | Continuous | 14 | 4.5 | 0.5 | 0.2 | 0.5 | 0.01 | | | | bal |
| | casting | | | | | | | | | | |
| Comp. Ex. 15 | Continuous | 14 | 4.5 | 0.5 | 0.8 | 0.5 | 0.01 | | | | bal |
| | casting | | | | | | | | | | |
| Comp. Ex. 16 | Continuous | 14 | 4.5 | 0.5 | 0.5 | 0.1 | 0.01 | | | | bal |
| | casting | | | | | | | | | | |
| Comp. Ex. 17 | Continuous | 14 | 4.5 | 0.5 | 0.5 | 1.0 | 0.01 | | | | bal |
| | casting | | | | | | | | | | |
| Comp. Ex. 18 | Continuous | 14 | 4.5 | 0.5 | 0.5 | 1.0 | 0.01 | 0.7 | | | bal |
| | casting | | | | | | | | | | |
| Comp. Ex. 19 | Continuous | 14 | 4.5 | 0.5 | 0.5 | 1.0 | 0.01 | | 0.4 | | bal |
| | casting | | | | | | | | | | |
| Comp. Ex. 20 | Continuous | 14 | 4.5 | 0.5 | 0.5 | 1.0 | 0.01 | | | 0.4 | bal |
| | casting | | | | | | | | | | |

Table 1 is a table showing composition components of the aluminum alloy materials (samples) of Examples 1 to 7 and Comparative Examples 8 to 20. Except for Example 7, each aluminum alloy molten metal having the composition shown in Table 1 was melted. Using each aluminum alloy molten metal, continuous casting was carried out with a casting diameter of 38 mm to obtain continuously cast materials of Examples other than Example 7 and Comparative Examples having a diameter of 38 mm. The obtained continuous cast materials were each subjected to a homogenization treatment at 470° C.×7 hours and air-cooled.

In Example 7, an aluminum alloy molten metal having the composition shown in Example 7 in Table 1 was melted. Using the aluminum alloy molten metal, continuous casting was carried out with a casting diameter of 210 mm to obtain an extruding billet having a diameter of 210 mm of Example 7. The billet 2 was heated to 350° C. and extruded to obtain an extruded material having a diameter of 38 mm of Example 7. The obtained extruded material was subjected to a homogenization treatment at 470° C.×7 hours and air-cooled.

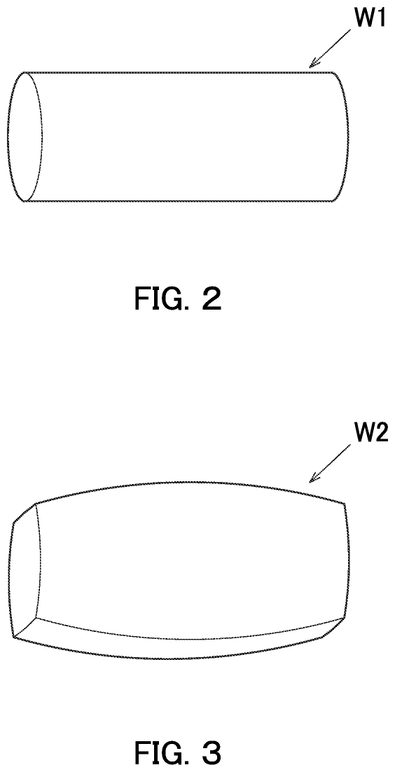

The continuous cast material and extruded material which had been air-cooled were cut to a length (L)=80 mm to obtain forging materials W1 of Examples and Comparative Examples as shown in FIG. 2. Subsequently, the obtained forging material W1 was subjected to hot forging at a material temperature of 420° C. and a die temperature of 180° C. In this forging, 50% of upsetting was performed in the direction (LT direction) perpendicular to the axial direction of the continuous cast material) to obtain a forged material (upset material) W2 for investigating material properties of Examples and Comparative Examples as shown in FIG. 3.

The forged material was heated at 500° C.×3 hours to perform a solution treatment, and then subjected to water quenching with water at 25° C. Then, it was subjected to an artificial aging treatment at 170° C.×8 hours to obtain a solution treated forged material (forged T6 treated product) Examples and Comparative Examples.

Next, in order to carry out the room temperature tensile test, a part of the forged T6 treated products of Examples and Comparative Examples were cut out to obtain room temperature tensile test pieces (samples) of Examples and Comparative Examples. As the shape of this test piece, the shape of the JIS No. 4 test piece was adopted, and a tensile test was performed on each test piece according to the regulation of JISZ2241, and the tensile strength was measured.

Further, in order to carry out the high temperature tensile test, the forged T6 treated products of Examples and Comparative Examples were preheated at 150° C.×100 hours, then partly cut out by cutting and high temperature tensile test pieces of Examples and Comparative Examples (sample) was obtained. As the shape of this test piece, the shape of the JIS No. 4 test piece was adopted, and a tensile test was performed on each test piece according to the regulation of JISZ2241, and the tensile strength was measured.

Further, in order to carry out the high temperature fatigue test, the forged T6 treated products of Examples and Comparative Examples were preheated at 150° C.×100 hours, then partly cut out by cutting process and prescribed shaped test pieces (samples) of Examples and Comparative Examples were obtained. And a fatigue test was performed on each test piece. Using the Ono type rotating bending test machine, the fatigue test was performed to measure 8 times for each test piece (alloy) to obtain an S-N curve. From the obtained S-N curve, the strength at the number of repetitions of 10⁷ times was obtained and was taken as fatigue strength.

In order to carry out the thermal expansion test, a part of the forged T6 treated products of the Examples and Comparative Examples was cut out by a cutting process to obtain test pieces (samples) of predetermined shapes of Examples and Comparative Examples. Then, a thermal expansion measurement was performed on each test piece. The thermal expansion measurement was measured in the range of 30° C. to 150° C. using a Rigaku's linear expansion measurement device (Thermo plus EVO) for each test piece.

The results of the room temperature tensile strength, the 150° C. tensile strength, the 150° C. fatigue strength, and the thermal expansion coefficient measured as described above are shown in Table 2. Also in Table 2, the room temperature tensile strength, the 150° C. tensile strength, the 150° C. fatigue strength, and the thermal expansion coefficient were evaluated as “⊚” (Excellent)”, “◯” (Good), “X” (Poor)” in three stages. In this evaluation, in the room temperature tensile strength, it was evaluated as “⊚” for 431 MPa or more, “◯” for 400 MPa to 430 MPa, and “X” for 399 MPa or less; in the 150° C. tensile strength, it was evaluated as “⊚” for 381 MPa or more, “◯” for 350 MPa to 380 MPa, and “X” for 349 MPa or less; in the 150° C. fatigue strength, it was evaluated as “⊚” for 156 MPa or more, “◯” for 150 MPa to 155 MPa, and “X” for 149 MPa or less; and in the thermal expansion coefficient, it was evaluated as “⊚” for 19.4×10⁶/K or less, “◯” for more than 19.4×10⁶/K to 19.9×10⁶/K or less, 20×10⁻⁶/K or more for “X”.

TABLE 2

| | Room temperature | | 150° C. tensile | | 150° C. fatigue | | Thermal expansion | |
|---|---|---|---|---|---|---|---|---|
| | tensile strength | | strength | | strength | | coefficient | |
| | MPa | | MPa | | MPa | | 10⁻⁶/K | |
| Ex. 1 | 426 | ◯ | 361 | ◯ | 158 | ⊚ | 19.6 | ◯ |
| Ex. 2 | 419 | ◯ | 362 | ◯ | 159 | ⊚ | 19.2 | ⊚ |
| Ex. 3 | 431 | ⊚ | 357 | ◯ | 155 | ◯ | 19.8 | ◯ |
| Ex. 4 | 417 | ◯ | 364 | ◯ | 162 | ⊚ | 19.5 | ◯ |
| Ex. 5 | 421 | ◯ | 359 | ◯ | 160 | ⊚ | 19.5 | ◯ |
| Ex. 6 | 422 | ◯ | 355 | ◯ | 160 | ⊚ | 19.5 | ◯ |
| Ex. 7 | 445 | ⊚ | 357 | ◯ | 164 | ⊚ | 19.5 | ◯ |
| Com. Ex. 8 | 442 | ⊚ | 392 | ⊚ | 158 | ⊚ | 20.7 | X |
| Com. Ex. 9 | 401 | ◯ | 368 | ◯ | 146 | X | 19.4 | ⊚ |
| Com. Ex. 10 | 430 | ⊚ | 349 | X | 145 | X | 19.5 | ◯ |
| Com. Ex. 11 | 436 | ⊚ | 362 | ◯ | 148 | X | 19.4 | ◯ |
| Com. Ex. 12 | 415 | ◯ | 348 | X | 142 | X | 19.8 | ◯ |
| Com. Ex. 13 | 438 | ⊚ | 372 | ◯ | 150 | ◯ | 20.5 | X |
| Com. Ex. 14 | 441 | ⊚ | 356 | ◯ | 148 | X | 20.4 | X |
| Com. Ex. 15 | 415 | ◯ | 348 | X | 143 | X | 19.9 | ◯ |
| Com. Ex. 16 | 454 | ⊚ | 374 | ◯ | 130 | X | 20.0 | X |
| Com. Ex. 17 | 381 | X | 361 | ◯ | 128 | X | 19.6 | ◯ |
| Com. Ex. 18 | 387 | X | 330 | X | 139 | X | 19.5 | ◯ |
| Com. Ex. 19 | 409 | ◯ | 342 | X | 148 | X | 19.4 | ⊚ |
| Com. Ex. 20 | 405 | ◯ | 338 | X | 149 | X | 19.4 | ⊚ |

| | | | | |
|---|---|---|---|---|
| Evaluation | 431 or more: ⊚ | 381 or more: ⊚ | 156 or more: ⊚ | 19.4 or less: ⊚ |
| method | 400 to 430: ◯ | 350 to 380: ◯ | 150 to 155: ◯ | more than |
| | 399 or less: X | 349 or less: X | 149 or less: X | 19.4 to 19.9: ◯ |
| | | | | 20 or more: X |

As is apparent from the results shown in Table 2, in the samples (test pieces) of Examples 1 to 7 in which the additive amounts of Si, Cu, Mg, Fe, Ni, Mn, Ti, and Zn were appropriately adjusted within the specific range and preferred range of the present invention, all of the room temperature tensile strength, the 150° C. tensile strength, the 150° C. fatigue strength, and the low thermal expansion coefficient could have obtained an excellent evaluation.

On the other hand, as shown in Comparative Examples 8, 14, and 16, in the sample in which the additive amount of Si, Fe, and Ni contributing to low thermal expansion was less than the specific range of the present invention, the thermal expansion coefficient is found to be high.

Further, as in Comparative Example 13, in the samples in which the additive amount of Mg contributing to high thermal expansion was larger than the specific range of the present invention, the thermal expansion coefficient is found to be high.

In the sample of Comparative Example 9, since the additive amount of Si is larger than the specific range of the present invention, it is found that the primary crystal Si is crystallized in large amount, and therefore the ductility is low and fatigue strength is low.

Furthermore, as in Comparative Examples 10 and 12, in the samples in which the additive amount of Cu and Mg contributing to the strength improvement in the 150° C. region is smaller than the specific range of the present invention, the improvement of strength due to age precipitation is small and fatigue strength is low.

Furthermore, in the sample of Comparative Example 11, since the additive amount of Cu is larger than the specific range of the present invention, the ductility is low and the fatigue strength is low due to the crystallization of the Al—Cu based compound.

In the sample of Comparative Example 15, since the additive amount of Fe is larger than the specific range of the present invention, it is found that the coarse Al—Fe—Si based compound is crystallized and its mechanical properties are low.

In the sample of Comparative Example 16, since the additive amount of Ni is less than the specific range of the present invention, dispersion strengthening by the crystallization of the Al—Ni—Cu based compound is weak and fatigue strength is low.

Further, in the sample of Comparative Example 17, since the additive amount of Ni is larger than the specific range of the present invention, it is found that the coarse Al—Ni—Cu based compound is crystallized and its mechanical properties are low.

Further, in the sample of Comparative Example 18, since the additive amount of Mn is larger than the specific range of the present invention, it is found that the coarse Al—Mn—Si based compound is crystallized and its mechanical properties are low.

Further, in the sample of Comparative Example 19, since the additive amount of Ti is larger than the specific range of the present invention, it is found that the coarse Ti based compound is crystallized and its mechanical properties are low.

Further, in the sample of Comparative Example 20, since the additive amount of Zr is larger than the specific range of the present invention, it is found that the coarse Zr based compound is crystallized and its mechanical properties are low.

As described above, in the samples (aluminum alloy materials) of Examples 1 to 7 including the gist of the present invention, the room temperature tensile strength, the 150° C. tensile strength, the 150° C. fatigue strength, and the thermal expansion coefficient are excellent, and even under severe usage environments such as high temperature environment, since it has sufficient fatigue strength and low thermal expansion coefficient, it can be particularly suitably used as a vehicle conrod.

On the other hand, the aluminum alloy material, which deviates from the gist of the present invention like the samples of Comparative Examples 8 to 20, the 150° C. tensile strength, the 150° C. fatigue strength, and the thermal expansion coefficient are inferior to the present invention. Therefore, the aluminum alloy material of the present invention is considered to be suitable for use in under high temperature environments.

The present application claims priority to Japanese Patent Application No. 2017-101481 filed on May 23, 2017, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

### INDUSTRIAL APPLICABILITY

The aluminum alloy material of the present invention can be suitably used, for example, as a connecting rod which is a connecting rod between a piston and a crank in an automobile internal combustion engine.

### DESCRIPTION OF REFERENCE SYMBOLS

W1: cast material (forging material)
W2: forged material (upset material)

1-4. (canceled)

5. A method for producing an aluminum material, comprising:
producing a cast material by casting an aluminum alloy molten metal having a composition consisting of: Si: 13 mass % to 15 mass %, Cu: 2.0 mass % to 6.0 mass %, Mg: 0.2 mass % to 1.5 mass %, Fe: 0.4 mass % to 0.8 mass %, Ni: 0.2 mass % to 0.8 mass %, P: 0.005 mass % to 0.015 mass %, and the balance being Al and inevitable impurities; and
producing an aluminum alloy material based on the cast material,
wherein the aluminum alloy material is produced by subjecting the cast material to a homogenization treatment, and then forging the homogenized cast material.

6. The method for producing an aluminum alloy material as recited in claim 5,
wherein the aluminum alloy molten metal includes Cu: 4.2 mass % to 4.8 mass %, Mg: 0.4 mass % to 0.6 mass %, and Fe: 0.4 mass % to 0.6 mass %.

7. The method for producing an aluminum alloy material as recited in claim 5,
wherein the aluminum alloy molten metal includes one or more of Mn: 0.01 mass % to 0.50 mass %, Ti: 0.01 mass % to 0.30 mass %, and Zr: 0.01 mass % to 0.30 mass %.

8. (canceled)

9. The method for producing an aluminum alloy material as recited in claim 5, wherein
the cast material is subjected to extrusion processing to produce an extruded material, and
the extruded material is subjected to a homogenization treatment, and then the homogenized extruded material is forged to produce an aluminum alloy material.

10. The method for producing an aluminum alloy material as recited in claim 5, wherein
the cast material is subjected to a homogenization treatment, and then the homogenized cast material is forged to produce a forged material, and
the forged material is subjected to a solution treatment, a water quenching treatment, and an artificial aging treatment to produce an aluminum alloy material.

11. The method for producing an aluminum alloy material as recited in claim 5, wherein
the cast material is subjected to a homogenization treatment and then forged to produce a forged material, and
the forged material is subjected to a solution treatment, a water quenching treatment, and an artificial aging treatment, and then subjected to a shot peening treatment to produce an aluminum alloy material.

12. A method for producing a connecting rod for vehicles, wherein
the connecting rod for vehicles is produced using the aluminum alloy material produced by the method as recited in claim 5.

13. The method for producing an aluminum alloy material as recited in claim 5, further comprising producing a connecting rod for vehicles from said aluminum alloy material.

14. The method for producing an aluminum alloy material as recited in claim 10, further comprising after the artificial aging treatment cutting the surface of the forged material by machining.

15. The method for producing an aluminum alloy material as recited in claim 10, further comprising after the artificial aging treatment and before the shot peening treatment cutting the surface of the forged material by machining.

16. The method for producing an aluminum alloy material as recited in claim 5,
wherein the aluminum alloy molten metal includes Si: 13.5 mass % to 14.5 mass %.

17. The method for producing an aluminum alloy material as recited in claim 5,
wherein the aluminum alloy molten metal includes Si: 14 mass %.
